(19) United States
(12) Patent Application Publication
(10) Pub. No.: US 2016/0214268 A1
(43) Pub. Date: Jul. 28, 2016

(54) SHARPENING ELEMENT FOR A CUTTING DEVICE

(71) Applicant: Mark Zaremski, Downers Grove, IL (US)

(72) Inventor: Mark Zaremski, Downers Grove, IL (US)

(21) Appl. No.: 15/093,389

(22) Filed: Apr. 7, 2016

Related U.S. Application Data
(63) Continuation-in-part of application No. 14/593,670, filed on Jan. 9, 2015.
Application No. 14/593,670 is a division of application No. 12/880,387, filed on Sep. 13, 2010, now Pat. No. 8,960,060.

(51) Int. Cl. B26D 7/12; B26D 1/30

(52) U.S. Cl. CPC B26D 7/12; B26D 1/30

(57) ABSTRACT

A cutting tool with a ruler connected to a track, a cutting device moveable along the track and a sharpening element positioned on the track. The cutting device includes a blade that contacts the sharpening element to sharpen the blade.

### CROSS REFERENCE TO RELATED APPLICATIONS

This application is a continuation-in-part of U.S. patent application Ser. No. 14/593,670, filed on 9 Jan. 2015, which is a divisional patent application of U.S. patent application Ser. No. 12/880,387, filed on 13 Sep. 2010, which issued as U.S. Pat. No. 8,960,060 on 24 Feb. 2015. The co-pending parent application is hereby incorporated by reference herein in its entirety and is made a part hereof, including but not limited to those portions which specifically appear hereinafter.

### BACKGROUND OF THE INVENTION

1. Field of the Invention

The present invention relates to cutting tables and devices of the type used in conjunction with either a guillotine cutter or a rotary cutter, and in particular to a sharpener element incorporated into the table to sharpen the cutting blade.

2. Discussion of Related Art

Cutting tables are used in conjunction with a cutting blade for making linear cuts in planar objects such as paper, fabric, roofing shingles, floor coverings, and the like. Typically, a cutting table has a planar upper surface and at least one elongate linear cutting edge against which a cutting blade is progressively moveable for advancing a cut across an object on the table.

The cutting edge for the table may extend along one side of the table body. Such tables are typically employed in a bypass cutter which has a curved guillotine blade having an inner end that is pivotally attached to the table and a handle at the outer end. By grasping the handle, the user can move the curved blade causing it to cut progressively along the length of the cutting edge, such that any object positioned on the table and extending across the edge will be cut by the blade.

A cutting table may also have a cutting edge that extends across a central portion of the upper surface of the table. Tables having centrally located cutting edges are generally referred to as slitters and employ rotary cutters. The typical rotary cutter is mounted on a slide bar that extends across the table parallel to the cutting edge. The rotary cutter is rotatably mounted on a holder and the holder is slideable along the slide bar. The blade is positioned to contact the cutting edge as the holder is progressively advanced along the slide bar.

Such cutting tables are employed in schools and businesses for cutting large quantities of material. In schools, the material is typically paper, but in the industrial sector many other materials are cut using cutting tables. The manufacturers of clothing and other objects made of fabric, for example, have cutting tables that are in constant use.

The usage of a cutting blade in conjunction with a cutting table gradually dulls the cutting blade. Where the blade and cutting table are in constant use, the gradual dulling of the blade results in a corresponding reduction in the efficiency of the cutting process. As a result, it is necessary to frequently sharpen or replace the cutting blade used in conjunction with the cutting table. Typically, the blade is only sharpened or replaced after it has become noticeably dull, and therefore the efficiency of the blade and table combination undergoes a repeating cycle wherein they operate efficiently together while the blade is sharp, but deteriorate over time as the dulling blade again causes inefficiencies. As a result of this repeating cycle, the quality of the output from a given blade and table combination is cyclical with some of the output being of poor quality. Also the blade and table combination must periodically be taken out of service while the blade is being sharpened or replaced.

It would be desirable to provide, therefore, an improved combination cutting blade and table that would include a sharpening element that would continuously sharpen the blade as it is used in conjunction with the table. Such a combination would result in a higher quality output and reduce or eliminate the need to periodically remove the combination of blade and table from service for sharpening.

### SUMMARY OF THE INVENTION

Briefly, the present invention is embodied in a cutting table of the type having a table body with a planar table surface. The table also has a linear cutting edge that extends along the table surface. A moveable cutting blade is employed with the table with the cutting blade progressively advancing along the cutting edge to make the cut.

In accordance with the invention, an elongate sharpening element extends along the cutting edge such that the cutting blade also progressively contacts the sharpening element for sharpening the blade as it is advanced across the table to make each cut.

In accordance with another embodiment, a cutting device of this invention comprises a ruler having a base and a cutting blade that runs along an edge of the base and may be depressed to cut a material positioned under the base. The cutting device further including an elongate sharpening element extending along the edge of cutting device such that the cutting blade also progressively contacts the sharpening element for sharpening the blade as it is advanced across the table to make each cut.

### BRIEF DESCRIPTION OF THE DRAWINGS

A better understanding of the invention will be had after a reading of the following detailed description taken in conjunction with the drawings wherein:

FIG. 1 is an isometric view of a guillotine cutter having a cutting table in accordance with the present invention;

FIG. 2 is a fragmentary enlarged cross-sectional view of the cutting table shown in FIG. 1 showing a cutting element in accordance with the invention positioned with respect to the cutting edge of the table;

FIG. 3 is a top view of the cutting table shown in FIG. 1;

FIG. 4 is a side view of a rotary cutter positioned with respect to a cutting table in accordance with another embodiment of the invention;

FIG. 5 is a top view of the cutting table shown in FIG. 4; and

FIG. 6 is a fragmentary enlarged cross-sectional view of the cutting table shown in FIG. 4, showing the cutting edge and cutting element therein in accordance with the present invention.

FIG. 7 is a perspective view of a ruler cutter of another embodiment of the present invention.

FIG. 8 is an isometric side view of a portion of the ruler cutter shown in FIG. 7.

FIG. 9 is an overhead view of a portion of the ruler cutter shown in FIG. 7.

FIG. 10 is a side cut-out view of a portion of a base of the ruler cutter shown in FIG. 8.

FIG. 11 is a side view of the ruler cutter of FIG. 7 in a retracted position.

FIG. 12 is a side view of the ruler cutter of FIG. 7 in an engaged position.

FIG. 13 is a rear view of a cutting device and a rotary blade in the retracted position according to an embodiment of this invention.

FIG. 14 is a rear view of the cutting device and the rotary blade in the engaged position according to an embodiment of this invention.

FIG. 15 is a side view of the cutting device and the rotary blade in the retracted position according to an embodiment of this invention.

### DETAILED DESCRIPTION OF THE PREFERRED EMBODIMENT

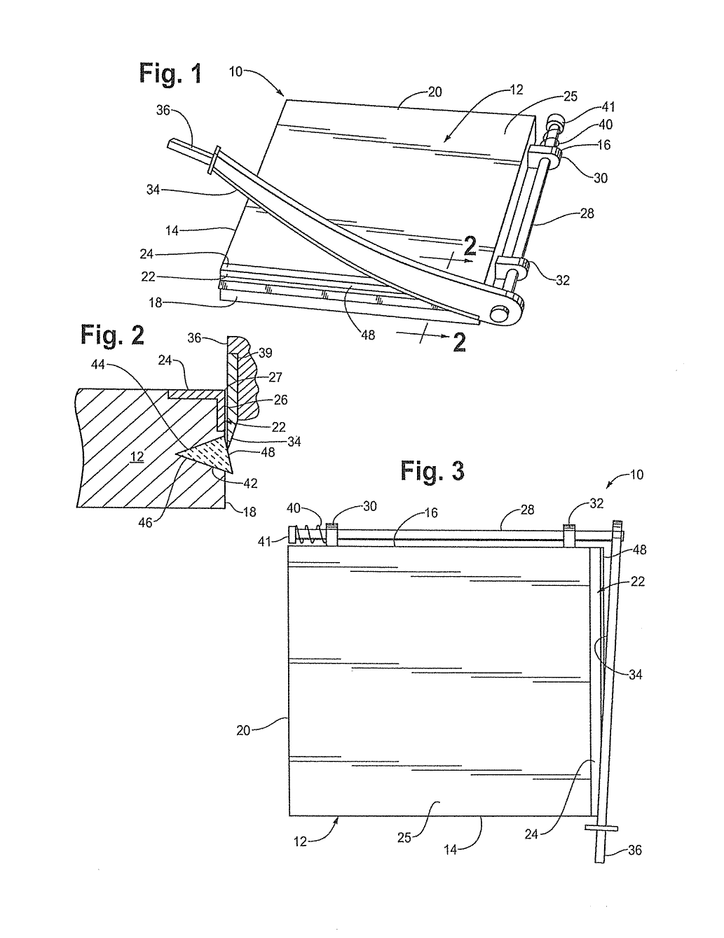

Referring to FIGS. 1, 2 and 3, a guillotine cutter 10 has generally rectangular cutting table 12. The cutting table 12 has a body with linear parallel sides 14, 16 and linear parallel ends 18, 20 oriented perpendicular to the sides 14, 16. One of the ends 18 has a metal insert 22 having an upper surface 24 parallel to the upper surface 25 of the table 12 and a vertical surface 26 that forms a sharp corner 27 with the upper surface 24 thereof. The elongate corner 27 formed by the intersection of the surfaces 24 and 26 forms a cutting edge of the table 12.

Positioned along one of the sides 16 of the table 12 is a cylindrical mounting bar 28 that is rotatably retained in parallel relationship to the side 16 by first and second mounting brackets 30, 32. Fixedly mounted, by a weld or other suitable means, at the outer end of the bar 28 is an arcuately shaped cutting blade 34. The cutting blade 34 has a handle 36 at the outer end thereof. The mounting bar 28 retain the blades 34 in an orientation that is generally transverse to the table 12 and nearly parallel to the cutting edge 24.

As best shown in FIG. 5, the blade 34 is not exactly perpendicular to the mounting bar 28 but is attached at a small angle such that the outer end of the blade 34 is slightly angled toward the far end 20 of the table 12. The blade 34 is urged toward the far end 20 of the table 12 by a coil spring 40 positioned around the circumference of the cylindrical bar 28 between the distal end 41 of the cylindrical bar 28 and one of the mounting brackets 30. The spring 40 urges the mounting bar 28 toward side 20. The coil spring 40 therefore urges the outer end of the blade 34 against the cutting edge 27. Accordingly, when an operator grasps the handle 36 and moves the blade 34 downwardly, the spring 40 continuously urges it against the cutting edge 27. Also, the arcuate structure of the blade 34 causes the contact point between the blade 34 and the cutting edge 27 to move progressively away from side 16 and toward side 14 to thereby make a cut.

In accordance with the present invention, positioned a short distance below the upper surface 25 is an elongate abrasive sharpening element 42. In the preferred embodiment, the sharpening element 42 is made of tungsten carbide and includes fine particles of hardened material such as a diamond power or the like embedded therein. The sharpening element 42 may have any cross-sectional shape. In the embodiment depicted, the cross-sectional shape is that of a triangle having sides 44, 46, 48, all of which are approximate equal in length. The sharpening element is embedded into the body of the cutting table 12 with one surface 48 have abrasive qualities and positioned to contact the blade 34 at a gradual angle 35. As the operator moves the handle 36 downwardly, the curve of the blade 34 causes the contact point between the blade 34 and sharpening element 42 to move progressively away from side 16 and toward side 14, thereby sharpening the cutting blade 34.

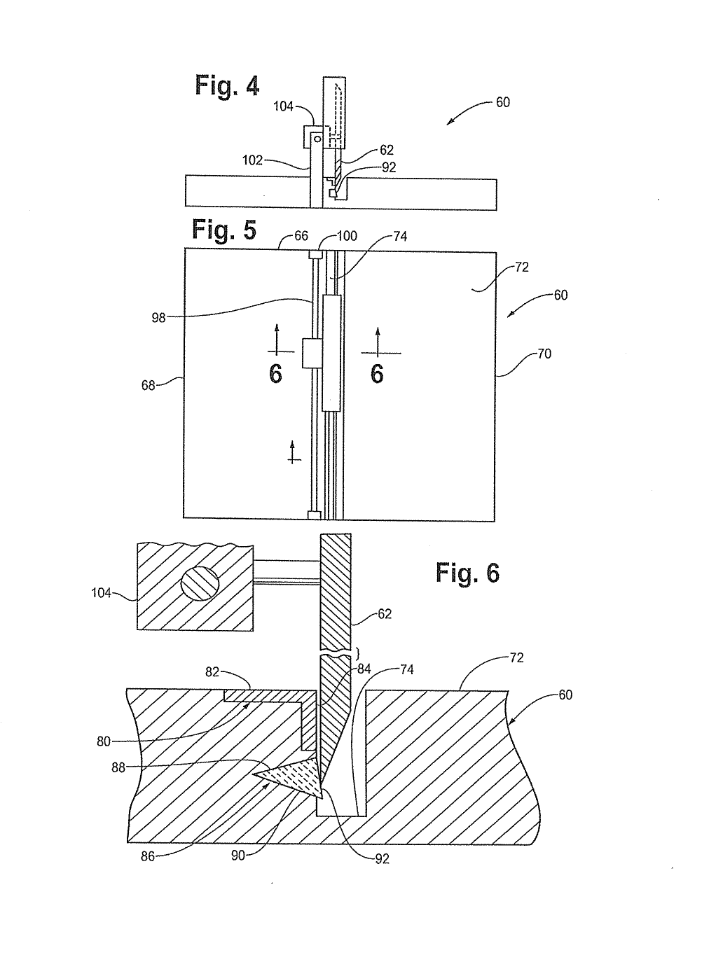

Referring to FIGS. 4, 5 and 6, the invention can also be incorporated into a cutting table 60 for use with a rotary blade 62. In this embodiment, the table 60 is generally rectangular in shape and has parallel sides 64, 66 and parallel ends 68, 70 that are perpendicular to the parallel sides 64, 66. The upper surface 72 of the table is planar, however a transverse groove 74 extends through the surface 72 parallel to the outer ends 68, 70 and perpendicular to the sides 64, 66. The groove 74 has linear parallel edges, unnumbered. A metal insert 80 extends across the table 60 with a surface 82 of the insert 80 being co-planar with the surface 72 of the table and has a second machined surface 84 perpendicular to the surface 82 such that the intersection of the surfaces 82 and 84 form an edge of the groove 74 along which the blade 62 is moveable to make a cut.

Positioned below the surface 72 of the table 60, and below the metal insert 80 is an elongate sharpening element 86 in accordance with the invention. The sharpening element 86 may have any cross-sectional configuration; however, in the embodiment depicted, the sharpening element has a triangular cross-section having sides 88, 90, 92, all three of which are nearly equal in width. The sharpening element 86 is made of a hardened material such a tungsten carbide, and may have hard particles embedded therein such as particles of a diamond powder. The diamond powder provides an abrasive quality to one of the surfaces 92 of the sharpening element. The surface 92 is also oriented at a gradual angle with respect to the second surface 84 of the insert 80 and is positioned so as to contact the edge of the rotatable blade 62.

The cutting table 60 further has an elongate rigid slide bar 98 that extends across the surface of the table 60 with the ends thereof retained with respect to the table on parallel mounting bars 100, 102, with one mounting bar 100 positioned midway alongside 64 of the table 60, and the other mounting bar 102 mounted midway alongside 66 thereof. The slide bar 98 is thereby rigidly retained with respect to the table 60. Slideable along the slide bar 98 is a retainer 104 having a hub 106 thereon for rotatably receiving the disc-shaped rotary blade 62. An arcuate shield 110 extends around the upper portions of the rotary blade 62 to prevent the blade 62 from cutting the hands of a user.

The retainer 104 retains the hub 106 and rotary blade 62 with respect to the slide bar 108 such that the blade 62 will cut along the cutting edge 78 of the cutting table.

As best shown in FIG. 4, the parts are configured such that the cutting edge of the rotary blade 62 will extend deep enough into the groove 104 to contact the sharpening surface 92 of the sharpening element 86, thereby sharpening the blade as the cutter is used to cut an object positioned on the table 60.

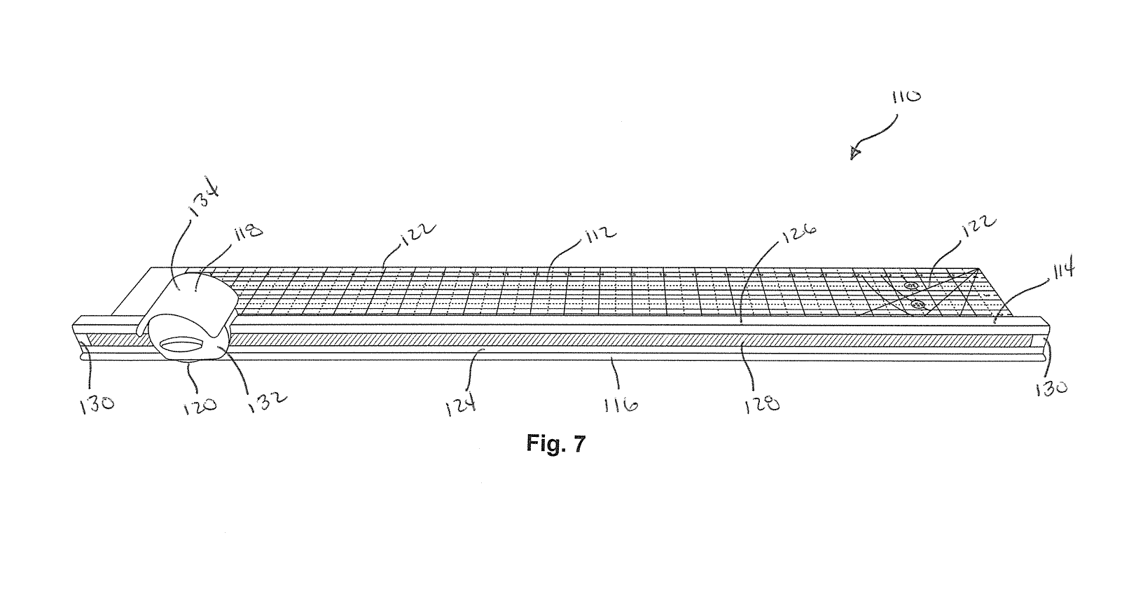

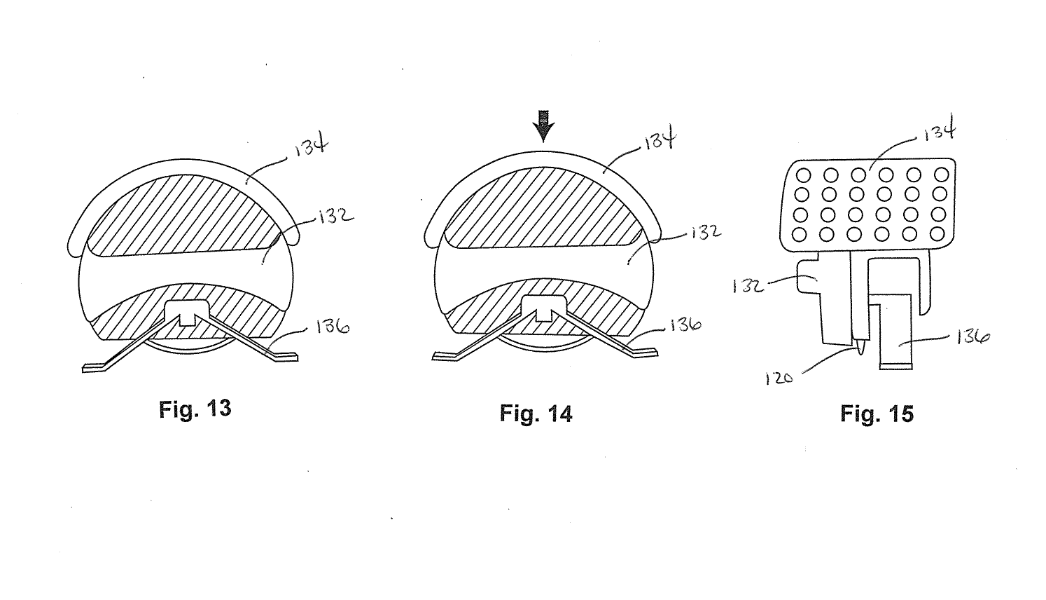

FIGS. 7-15 show a cutting tool 110 according to another embodiment of this invention. As shown in FIG. 7, the cutting tool 110, also referred to as a ruler cutter, of this invention includes a ruler 112 connected to a track 114 along an edge of the ruler 112 and a sharpening element 116 positioned along a lower portion of the track 114. The track 114 provides a path for a cutting device 118 to slide along. In this embodiment, the cutting device 118 includes a rotary blade 120 comprising a rotatable disc with a sharpened outer circumference. However, it should be understood that the blade is not limited to this type and may comprise any type of blade known to someone of skill in the art.

In a preferred embodiment, the ruler 112 is manufactured from a durable acrylic clear plastic with markings 122 for measuring and lining up a material to be cut. However, the planar ruler 112 may not be manufactured of acrylic and may be manufactured of any material known to one of skill in the art. In alternative embodiments, the ruler 112 may not be clear. The markings 122 may include any markings that assist a seamstress and/or a craftsperson create a design including, but not limited to, measurements, angles, grids, dots, and/or patterns. In the embodiment shown in FIG. 7, the ruler 112 has a straight planar rectangular shape having dimensions of approximately 4 inches wide, 30 inches long, and ⅛ inch high. However, it should be understood that the ruler 112 of this invention is not limited to the described shape and dimensions and may comprise any shape, including curves, and may include alternative dimensions. In a preferred embodiment, the planar ruler 112 further includes non-slip grips to prevent the cutting ruler 110 from moving during a cut.

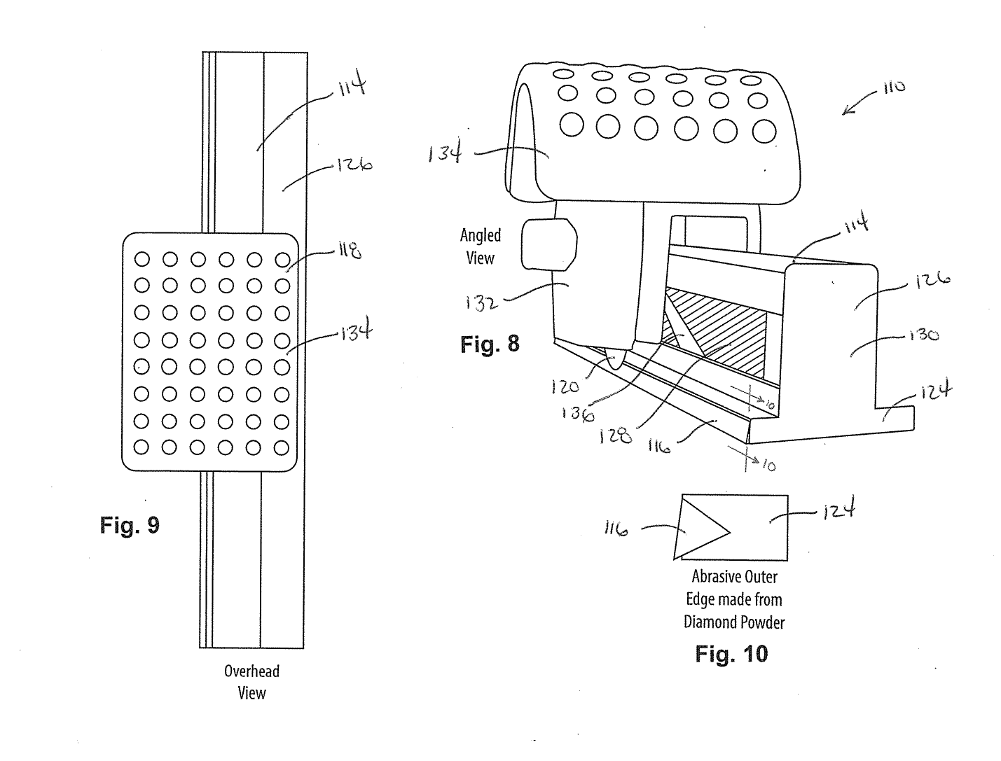

As shown in FIG. 8, the track 114 preferably comprises a base 124 and a ridge 126 upon which the cutting device 118 moves. The ridge 126 further includes an interior void with a slot 128 providing access to the interior void. In this embodiment the cutting device 118 straddles the ridge 126 with a spring portion of the cutting device 118 extending into the interior void through the slot 128. The track 114 preferably further includes a pair of end caps 130 to prevent the cutting device 118 from sliding past an end of the track 114. In this embodiment, the track 114 is manufactured from aluminum and plastic however it should be understood that the track 114 may be manufactured from other materials that provide a durable device capable of repeated cuts. In this embodiment, the track 114 is a straight section comprising an inverted T-shape with dimensions of approximately 1 3/16 inches wide, 1 inch high, and 30 inches long. However, it should be understood that the track 114 of this invention is not limited to this shape and/or dimensions.

As best shown in FIG. 10, the track 114 further includes the sharpening element 116 embedded in the base 124. In this embodiment, the sharpening element 116 is made of tungsten carbide and includes fine particles of hardened material such as a diamond power or the like embedded therein. The sharpening element 116 may have any cross-sectional shape. In the embodiment depicted, the cross-sectional shape is that of a triangle having sides which are approximately equal in length. The sharpening element 116 is embedded into the base 124 of the track 114 with one surface positioned to contact the blade 120 at a gradual angle. As the operator moves the cutting device 118 along the track 114, the blade 120 contacts the sharpening element 116 thereby sharpening the blade 120. In an alternative embodiment, the sharpening element 116 is not embedded into the base and instead is connected with adhesive or another type of connector. In a preferred embodiment, a profile of the sharpening element 116 corresponds to a blade profile of a cutting edge of the blade 120.

As best shown in FIGS. 8 and 13-15, the cutting device 118 comprises a housing 132 partially enclosing the rotary blade 120, a grip 134 and a spring 136. In this embodiment, the housing 132 is manufactured from plastic, the grip 134 is manufactured from rubber and the spring 136 is manufactured from metal. However, it should be understood that he cutting device 118 may be manufactured from any material known to one of skill in the art. As shown in the embodiment of FIGS. 8-15, the housing 132 straddles the ridge 126 of the track 114 with the spring 136 positioned within the slot 128. In an embodiment of this invention, the cutting device 118 further includes a gear that engages a rack on the track 114 to rotate the rotary blade 120 as the cutting device 118 moves along the track 114.

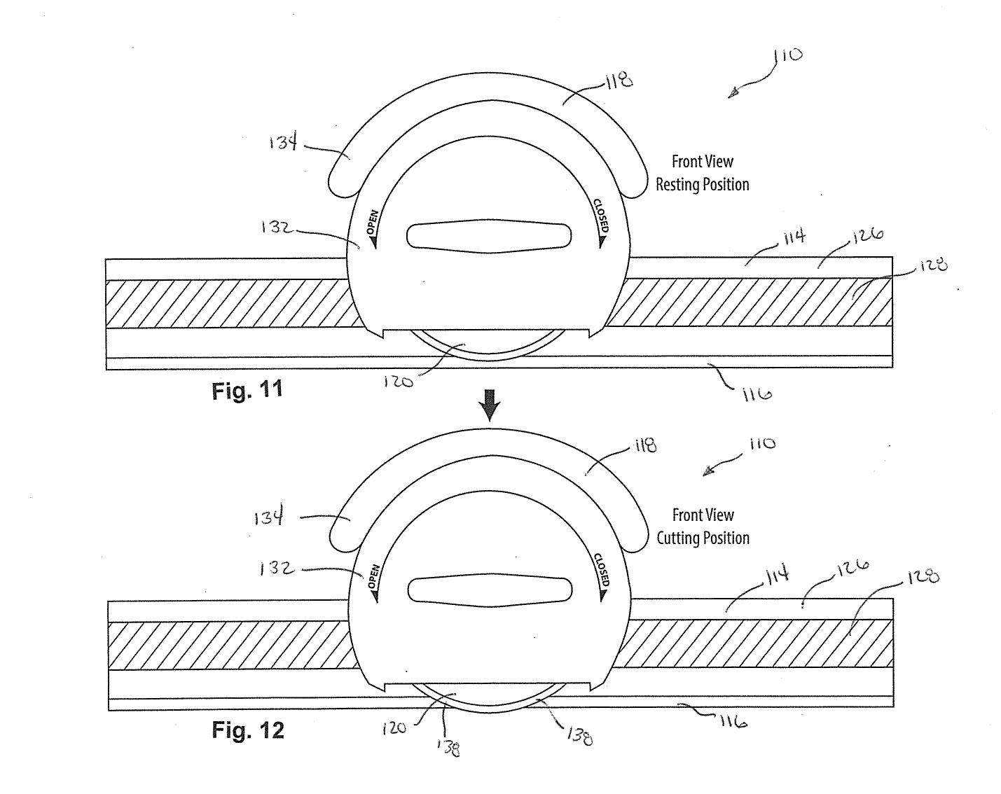

In an embodiment of this invention, the cutting tool 110 includes a retracted position, as shown in FIG. 11, and an engaged position, as shown in FIG. 12.

In the retracted position, the spring 136 is in an un-tensioned state and the rotary blade 120 is elevated from a bottom of the cutting tool 110. In the retracted position, the blade 120 preferably does not contact the sharpening element 116 and cannot cut a material placed under the cutting tool 110. Preferably, the cutting device 118 further includes a cover to cover an exposed portion of the blade 120 to prevent potential injury from the exposed blade.

In the engaged position, the cutting device 118 is pressed downward placing the spring 136 into a tensioned state and a portion of the blade 120 extends below the bottom of the ruler cutter 110, as shown in FIG. 12. The operator moves the cutting device 118 along the track 114 while pressing down on the cutting device 118 to cut a material placed under the ruler cutter 110. As shown in FIG. 12, while in the engaged position, portions 138 of the rotary blade 120 contact the sharpening element 116, thereby sharpening the rotary blade 120 with each cut. In a preferred embodiment, the rotary blade 120 rotates as the cutting device 118 moves along the track to ensure the entire blade edge is sharpened.

In an alternative embodiment, the cutting tool 110 cuts in the engaged position and is sharpened while in the retracted position. In this embodiment, while in the retracted position, a cutting edge of the rotary blade 120 is aligned with the sharpening element 116. To sharpen the blade, an operator moves the cutting device along the track 114 and the sharpening element 116 without pressing downward on the cutting device. In this embodiment, in the engaged position, the blade 120 preferably does not contact the sharpening element 116 while the operator moves the cutting device 118 along the track 114 to cut a material placed under the ruler cutter 110. In this embodiment, the ruler cutter 110 may further include a spacer to prevent the blade 120 from contacting the sharpening element 116 while in the engaged position.

While the present invention has been described with respect to multiple embodiments, it will be appreciated that many modifications and variations may be made without departing from the spirit and scope of the invention. It is therefore the intent of the following claims to cover all such modifications and variations that fall within the spirit and scope of the invention.

1. A cutting tool comprising:
a ruler;
a track connected along an edge of the ruler;
a sharpening element positioned on the track; and
a cutting device slideable along the track, the cutting device including a blade and wherein the cutting device cuts a material positioned under the cutting tool by pressing downward on the cutting device towards the material and sliding the cutting device along the track while sharpening a portion of the blade in contact with the sharpening element.

2. The cutting tool of claim 1, wherein the cutting device includes a spring to bias the cutting device upward.

3. The cutting tool of claim 2, wherein the sharpening element extends along a lower edge of the track and the blade is sharpened by sliding the blade along the sharpening element.

4. The cutting tool of claim 1, wherein the blade is a rotatable disc with a sharpened outer circumference.

5. The cutting tool of claim 1, wherein the sharpening element is embedded into a base of the track.

6. The cutting tool of claim 1, wherein the sharpening element includes a sharpening surface, the sharpening surface including a profile that complements a blade profile of an edge of the blade.

7. The cutting tool of claim 1, wherein the sharpening surface extends at a gradual angle away from a surface of the track.

8. The cutting tool of claim 1, wherein the sharpening element comprises at least one of tungsten carbide and diamond powder.

9. A cutting tool comprising:
a ruler including a rectangular shape with markings for aligning a material to be cut;
a track connected along an edge of the ruler;
a sharpening element positioned on the track; and
a cutting device positioned on and slideable along the track, the cutting device including a blade and a spring, wherein the cutting device operates in an engaged position and a retracted position, wherein in the engaged position the cutting device is pressed downward with a portion of the blade extending below a bottom surface of the cutting tool and the spring is in a tensioned state and the cutting device slides along the track to cut the material and wherein in the retracted position the blade is above the bottom surface and the spring is in an untensioned state and the blade is in contact with the sharpening element.

10. The cutting tool of claim 9, wherein in the engaged position the cutting device slides along the track to cut the material.

11. The cutting tool of claim 9, wherein in the retracted position the cutting device slides along the track to sharpen the blade on the sharpening element.

12. The cutting tool of claim 9, wherein the sharpening element extends along a lower edge of the track and the blade is sharpened by sliding the blade along the sharpening element.

13. The cutting tool of claim 9, wherein the blade is a rotatable disc with a sharpened outer circumference.

14. The cutting tool of claim 9, wherein the sharpening element includes a sharpening surface, the sharpening surface including a profile that complements a blade profile of an edge of the blade.

15. The cutting tool of claim 14, wherein the sharpening surface extends at a gradual angle away from a surface of the track.

16. The cutting tool of claim 9, wherein the sharpening element comprises at least one of tungsten carbide and diamond powder.

17. A cutting tool comprising:
a ruler including a rectangular shape with markings for aligning a material to be cut;
a track connected along an edge of the ruler;
a sharpening element positioned on the track; and
a cutting device positioned on and slideable along the track, the cutting device including a blade and a spring, wherein the cutting device includes an engaged position and a retracted position;
wherein in the engaged position the cutting device is pressed downward with a portion of the blade extending below a bottom surface of the cutting tool and the spring is in a tensioned state and the cutting device may be slid along the track to cut the material while simultaneously sharpening a portion of the blade on the sharpening element; and
wherein in the retracted position the blade is above the bottom surface and the spring is in an untensioned state and the blade does not contact the sharpening element.

18. The cutting tool of claim 17, wherein the blade is a rotatable disc with a sharpened outer circumference.

19. The cutting tool of claim 17, wherein the sharpening element includes a sharpening surface and the sharpening surface including a profile that complements a blade profile of an edge of the blade.

20. The cutting tool of claim 17, wherein the sharpening element includes at least one of tungsten carbide and diamond powder.
